(19) United States
(12) Patent Application Publication
(10) Pub. No.: US 2003/0059566 A1
(43) Pub. Date: Mar. 27, 2003

(54) Sticky tape tearing mechanism

(76) Inventor: Po-Wei Chien, Taipei city (TW)

Correspondence Address: DOUGHERTY & TROXELL, 5205 LEESBURG PIKE, SUITE 1404, FALLS CHURCH, VA, 22041, US

(21) Appl. No.: 09/865,715

(22) Filed: Sep. 24, 2001

(51) Int. Cl. G09F 3/00

(52) U.S. Cl. 428/43

(57) ABSTRACT

This invention is a sticky tape tearing mechanism, involving mainly a tape-tearing unit in the exterior shape of a rectangle, square or band, composed of such break-resistant materials as paper, fabric, metal foil or plastic film, which are laminated by hot melting or glue adhesion process, to be installed on a sticky tape at appropriate intervals. At least on one transverse side of the tape-tearing unit is a V-shaped cut, serrated dents or spaced holes. Several tape-tearing units are adhered at specified intervals on a coil of sticky tape, so that when the sticky tape is used to seal a box unit or any other package, the user can use his fingers to pick up the tape-tearing unit, or tear the sticky tape at the V-shaped cut, serrated dents or spaced holes, to facilitate sticky tape tearing process.

### BACKGROUND OF THE INVENTION

1. Field of the Invention

This invention relates to a sticky tape tearing mechanism, particularly a tape-tearing mechanism to facilitate sticky tape tearing process without having to cut the sticky tape.

2. Background of the Invention

A sticky tape is generally used to seal a carton, package or bag. Such a seal that involves a highly adhesive sticky tape simply could not be opened merely by hand. It requires a sharp tool or cutting knife to cut the sticky tape, and the process can be labor and time consuming.

### BRIEF DESCRIPTION OF THE INVENTION

The main objective of this invention is to provide a sticky tape mechanism, involving a tape-tearing unit that is composed of the lamination of break-resistant materials by hot melting or adhesive gluing process. At least on one transverse side of the tape-tearing unit is a V-shaped cut, serrated dents or spaced holes. Several pieces of the tape-tearing units are adhered at appropriate intervals on a coil of sticky tape, in a way that when the sticky tape is used to seal a box unit or a package, the V-shaped cut or serrated dents or holes on the tape-tearing unit can be broken to tear the sticky tape apart, thus avoiding the trouble of cutting process, and the sticky tape can be torn in a more convenient and speedy way.

Another objective of this invention lies in the feature that several holes are properly spaced at the center of the tape-tearing unit, so that when the sticky tape is used to seal a box unit or a package, the user can use his fingers to pick the tape-tearing unit and open the seal.

### BRIEF DESCRIPTION OF DRAWINGS

The main features and novelty of this invention can be, better understood from the following drawings of preferred embodiment, which are explained in details as follows.

FIG. 1 is a perspective view of this invention.

FIG. 2 is another preferred embodiment of the invention.

FIG. 3 is a perspective view of the invention.

FIG. 4 and FIGS. 4A to 4C illustrate different compositions of the invention.

FIGS. 5, 6 and 7 are embodiment views of the invention.

FIG. 8 is a perspective view of this invention when it is adhered to a coil of sticky tape.

FIG. 9 is an embodiment view of the invention when applied to an envelope or document bag.

FIG. 10 is a perspective view of another embodiment of the invention.

FIG. 11 is a perspective view of another embodiment of the invention.

FIGS. 12 and 13 illustrate another embodiment of the invention in application to a box unit.

FIGS. 14, 15 and 16 illustrate another embodiment of the invention in application to a bag unit.

### BRIEF DESCRIPTION OF NUMERALS

1 sticky tape

2 tape-tearing unit

3 cut

4 metal foil

5 plastic film

6 polymer plastic

7 fabric material

8 paper material

9 box unit

10 envelope

101 seal opening

21 hole

### DETAILED DESCRIPTION OF THE INVENTION

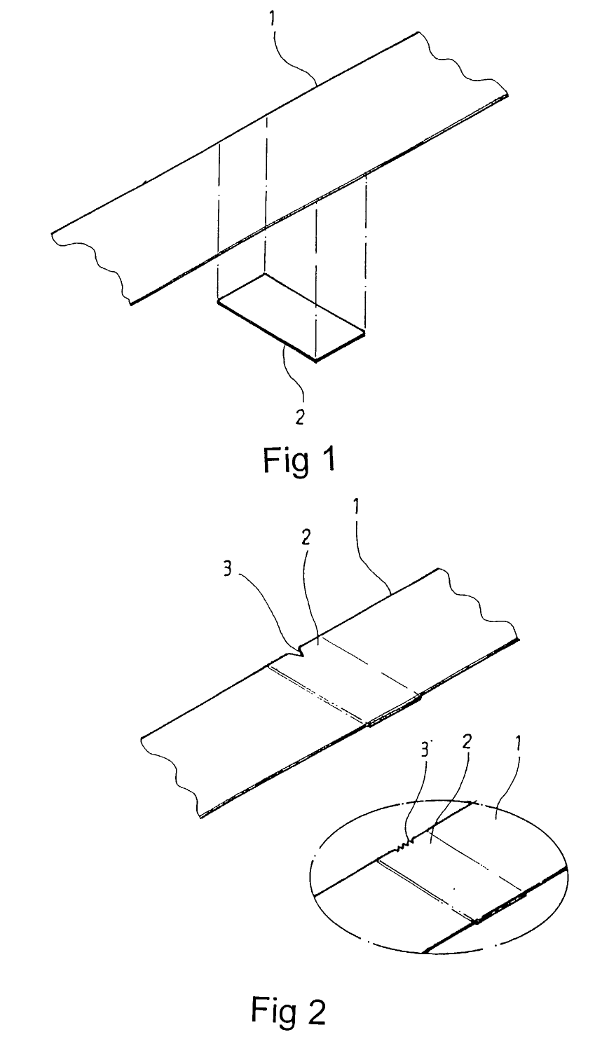

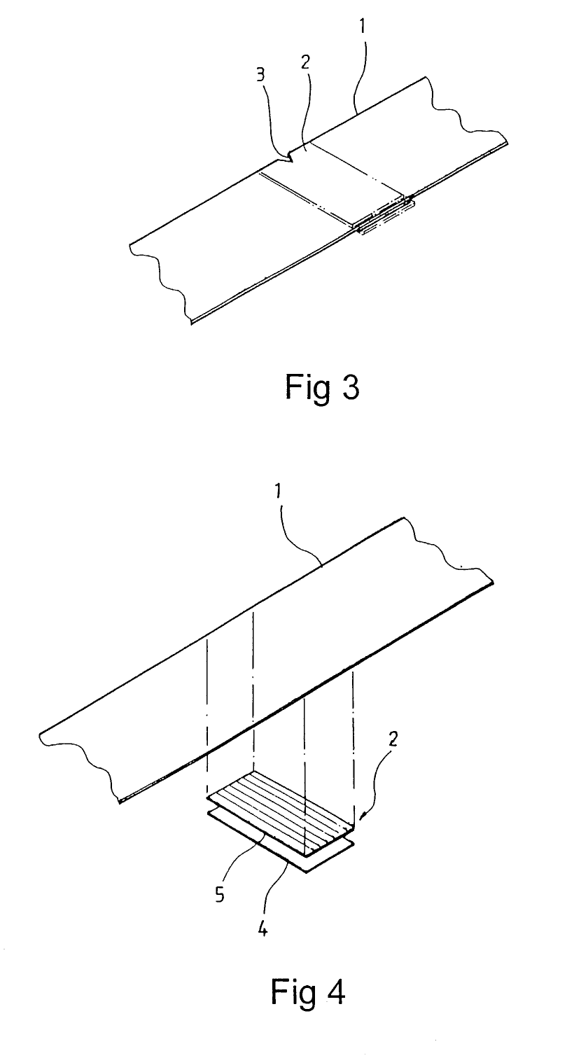

As shown simultaneously in FIGS. 1, 2 and 3, this invention involves mainly a tape-tearing unit 2 made of break-resistant materials in a rectangle, a square or any other shape, the tape-tearing unit 2 being adhered to the front or reverse side of a sticky tape (OPP). At least on one of the lateral sides of the tape-tearing unit 2 is a V-shaped or serrated cut 3, the other side being flush with, shorter than or longer than the side of the sticky tape 1, to the effect that when the sticky tape 1 is used to seal a carton or a bag, the V-shaped or serrated cut 3 will serve as a means to tear off the sticky tape 1 (the cut 3 can be designed as multiple holes).

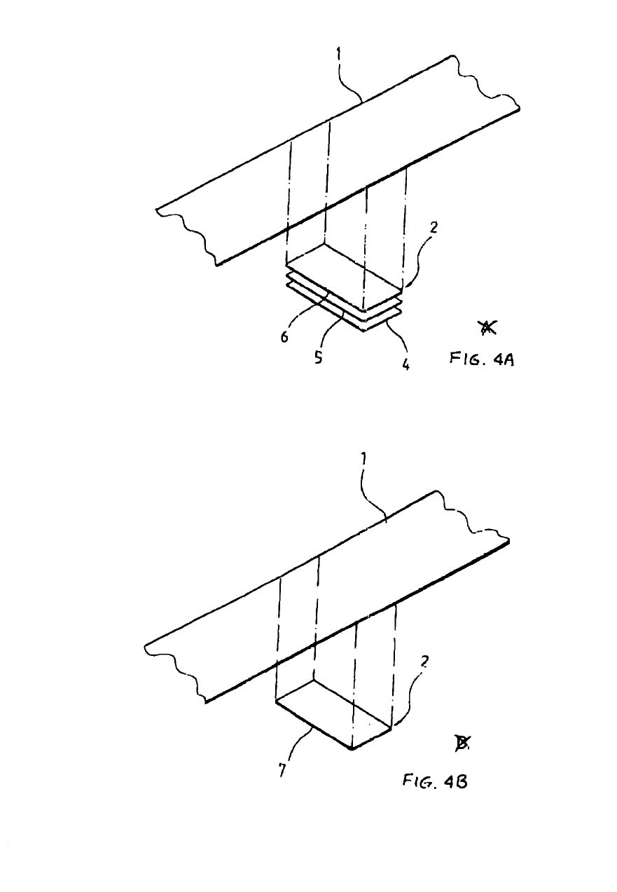

As shown in FIG. 4, this invention of tape-tearing unit 2 is a lamination of one layer of metal foil 4 with one layer of PVC flexible plastic film 5 (its surface applied with pressure to have continuous grains of transverse, corrugated, parallel, straight lines, for the purpose to keep the torn-off end straight and even after the sticky tape 1 is torn off apart) and is adhered to the main body of the sticky tape 1.

The tape-tearing unit 2 can also be composed of a metal foil 4, a PVC flexible film 5, and a PP or PE plastic material 6, to be adhered to the main body of the sticky tape 1 (as shown in FIG. A):

The tape-tearing unit 2 can also be composed of a fabric, 7 and a sticky tape 1 (shown in FIG. B), or a paper material 8 or a flexible PVC film 5 pasted to the sticky tape 1 (shown in FIG. C).

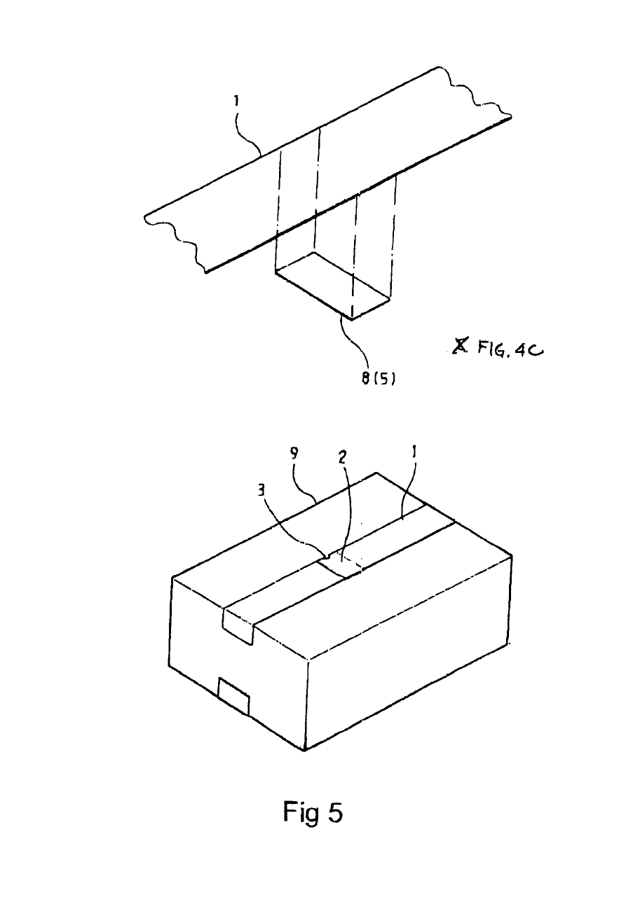

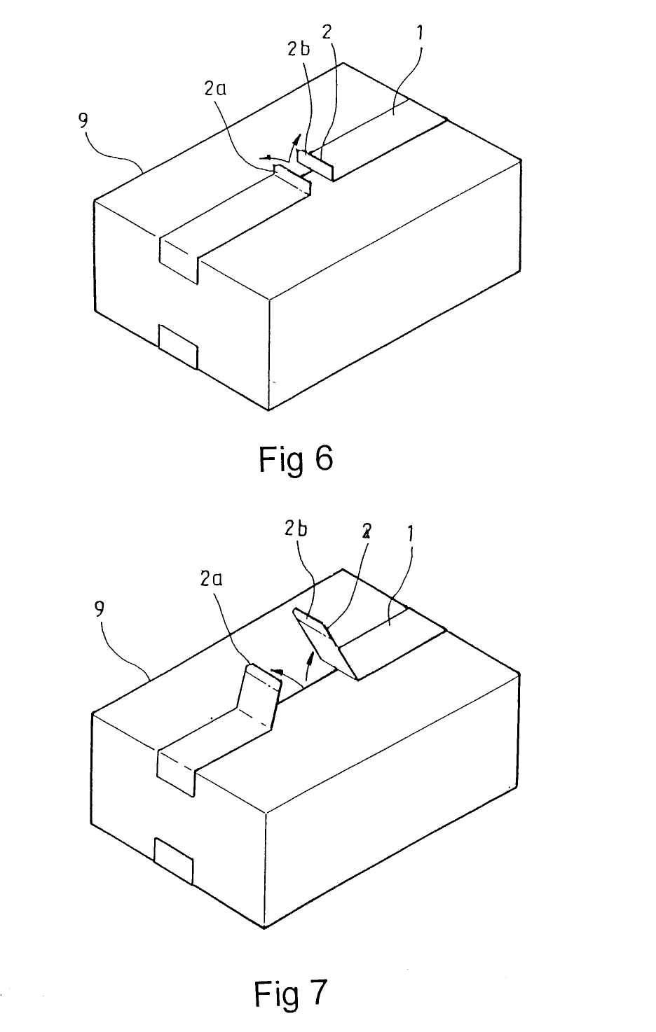

As shown in FIGS. 5 to 7 that illustrate how this invention is in application. A specified length of the sticky tape 1 equipped with a tape-tearing unit 2 is used to seal a box unit 9, the tape-tearing unit 2 being placed flat on the surface of the box unit 9. To open the seal, the user can use his fingers to tear at the V-shaped or serrated cut 3 in a longitudinal direction to tear off the tape-tearing unit 2 along with the sticky tape 1, forming two free ends 2a, 2b. Since there is no adhesive glue on the bottom side of the tape-tearing unit 2, the user's fingers will not feel sticky. Therefore, the user can use his both hands to pull the free ends 2a, 2b to the farther sides of the box unit 9 and open the seal.

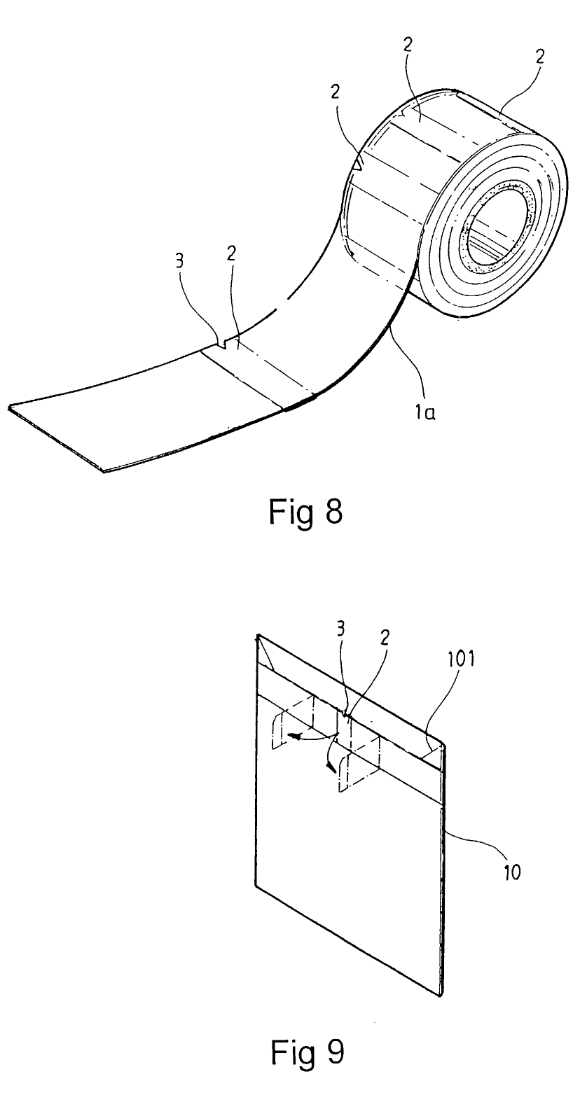

As shown in FIG. 8, several pieces of this invention of tape-tearing unit 2 are adhered to a coil of sticky tape 1 a at certain intervals. When the sticky tape 1 a is used to seal a carton, one tape-tearing unit 2 can be located at the center or an appropriate position of the sticky tape 1a.

As shown in FIG. 9, a sticky tape 1 equipped with this invention of tape-tearing unit 2 can be used to seal the opening 101 of an envelope or a document bag 10. In the same way, the seal can be opened when the user tears at the V-shaped or serrated cut 3, thus requiring no cutting process while the bag can still maintain its neat appearance.

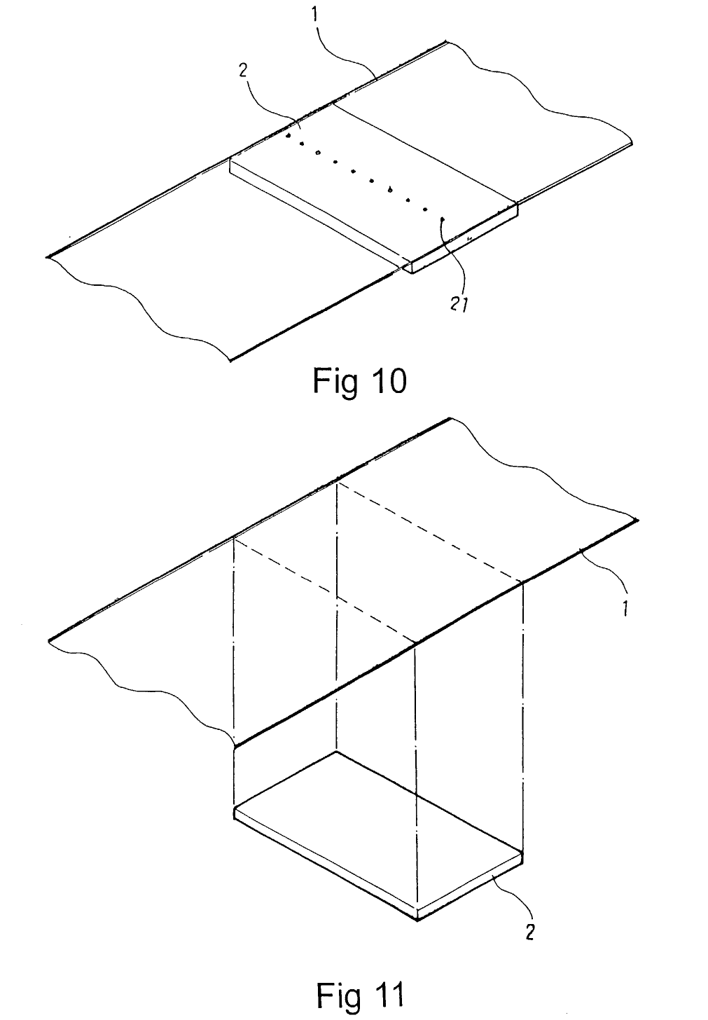

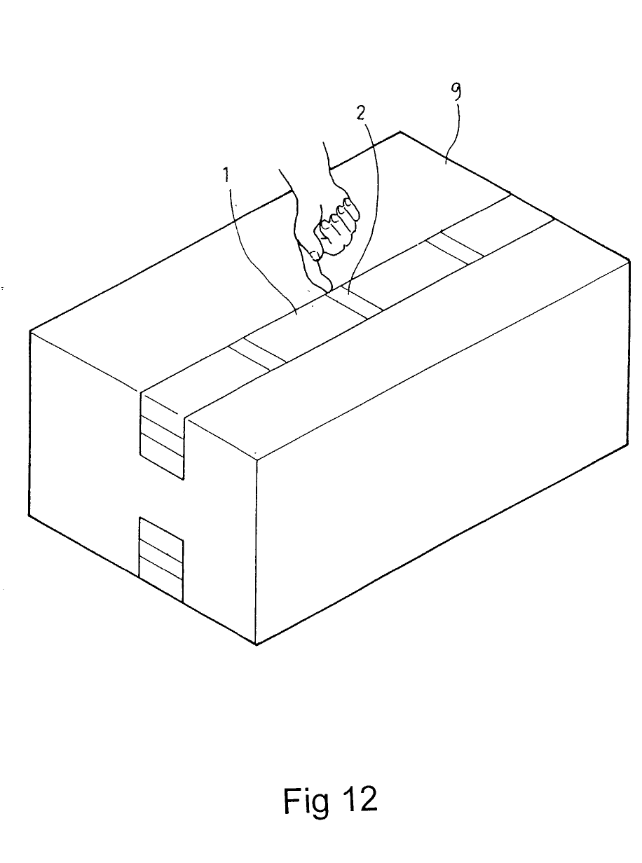

As shown in FIGS. 10 and 11, this invention of tape-tearing unit 2 can also be designed to involve no cuts or serration. At the center of the tape-tearing unit 2 is the arrangement of several holes 21, so that when the tape-tearing unit 2 is pasted on a carton or bag, the user need only pick at the side of the tape-tearing unit 2 and lift it up to achieve the objective of tearing off the sticky tape 1.

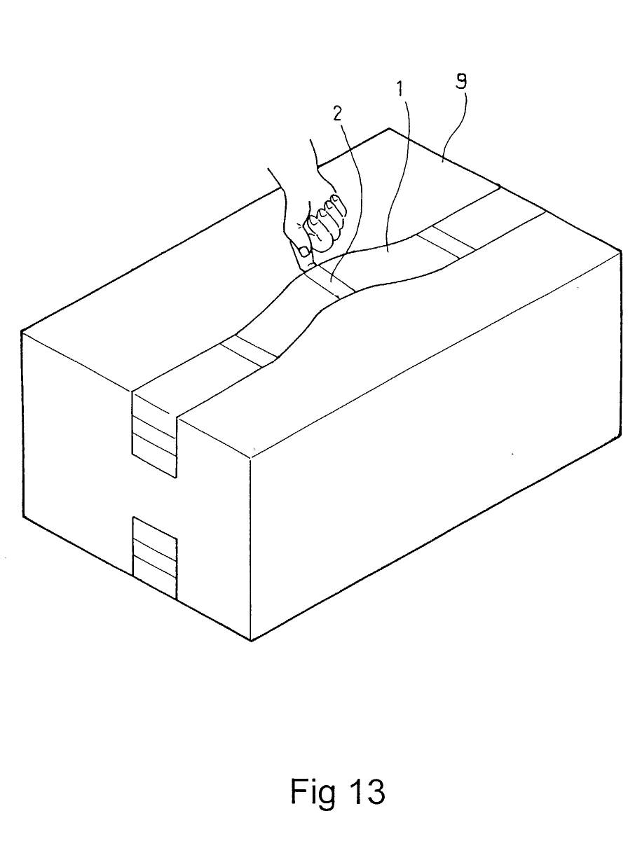

As shown in FIGS. 12 and 13, when this invention is applied to seal a box unit 9 as in FIG. 10, it is a well-known product of sticky tape 1 sticking on the seal of the box unit 9. One thing worth noticing is that, a tape-tearing unit 2 is reserved near the cut end of the sticky tape to facilitate tearing off. To tear it off, the user need only use his fingers to pick up the bottom side of any one tape-tearing unit 2 (since the bottom side of the tape-tearing unit 2 is not sticky, so it can be picked up easily without trouble) before tearing off the sticky tape 1 along the seal.

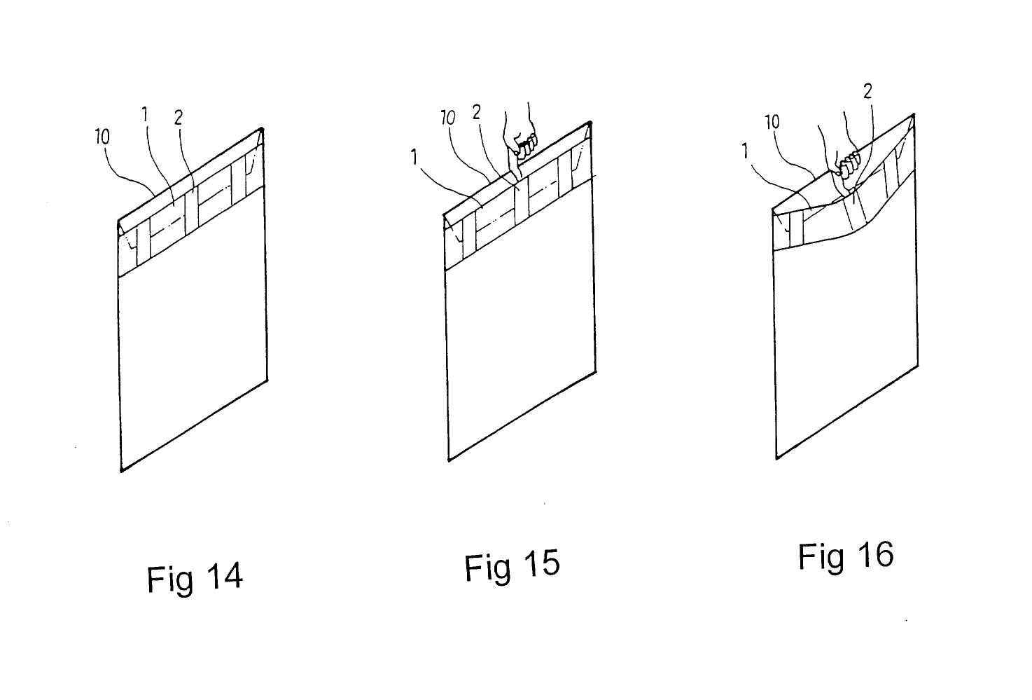

As shown in FIGS. 14 to 16, the embodiment of this invention shown in FIG. 10 can also be used to seal an envelope or document bag 10. Likewise, the user can use his finger to pick up the side of any one tape-tearing unit 2 to tear open the sticky tape along the seal.

What is claimed is:

1. A sticky tape tearing mechanism, involving a tape-tearing unit made of break-resistant materials that are laminated by hot-melting or gluing process, in an appropriate shape (such as: a rectangle, square or band), at least one piece or several pieces of the tape-tearing unit being pasted at specified intervals onto a sticky tape, at least on one transverse side of the tape-tearing unit adhered to the sticky tape being a V-shaped dent, serrated dents or an otherwise shaped cut, hole or a tear opening, the cut or hole serving to facilitate tearing off the sticky tape by tearing the cut, the hole or the tear opening of the sticky tape in two parts, forming respectively a grip holder, the grip holders can then be pulled apart to opposite sides to open the case, when the sticky tape is used to seal a box unit or any packages.

2. The tape-tearing mechanism for sticky tape as claimed in claim 1, wherein the tape-tearing unit is a lamination of a metal foil and a flexible PVC film.

3. The tape-tearing mechanism for sticky tape as claimed in claim 1, wherein the material of the tape-tearing unit is, either one or the combination of, a metal foil, flexible PVC film, PP & PE plastic matter.

4. The tape-tearing mechanism for sticky tape as claimed in claim 1, wherein the material of said tape-tearing unit is paper.

5. The tape-tearing mechanism for sticky tape as claimed in claim 1, wherein transverse, corrugated, parallel, straight lines are compressed continuously on the surface of said tape-tearing unit, or the surface is affixed with material that can be neatly torn apart, to facilitate neat tearing ends when the tape-tearing unit is torn apart.

6. The tape-tearing mechanism for sticky tape as claimed in claim 1, wherein the tape-tearing unit is flush with two side edges of the sticky tape, or extended beyond the edges of the sticky tape, or shorter than the edges.

7. The tape-tearing mechanism for sticky tape as claimed in claim 1, wherein the tape-tearing unit is located on the adhesive side or non-adhesive side of the sticky tape.

8. The tape-tearing mechanism for sticky tape as claimed in claim 1, wherein the bottom side of the tape-tearing unit is slightly adhesive or wholly or partially free from a coating of adhesive glue.

9. The tape-tearing mechanism for sticky tape as claimed in claim 1, wherein at the center of the tape-tearing unit or at another appropriate location is an arrangement of separate holes to facilitate tearing off of the tape.

10. The tape-tearing mechanism for sticky tape as claimed in claim 1, wherein on the surface of the tape-tearing unit is printed patterns or letters or characters.

11. The tape-tearing mechanism for sticky tape as claimed in claim 1, wherein on the surface of the tape-tearing unit is coated with an appropriate amount of tear-assistant agent to facilitate tearing off process.

12. The tape-tearing mechanism for sticky tape as claimed in claim 1, wherein the tape-tearing unit is made in the shape of a rectangle, a square or any other geometrical configurations.

13. The tape-tearing mechanism for sticky tape as claimed in claim 1, wherein at least one tape-tearing unit is installed on a coil of sticky tape, on a specific length of adhesive tape body or a section of sticky tape, or somewhere between two sections. of specified adhesive tape ends.

14. The tape-tearing mechanism for sticky tape as claimed in claim 1, wherein longitudinally at the center of said tape-tearing unit is coated with aromatic
